(19) United States
(12) Patent Application Publication
(10) Pub. No.: US 2023/0109884 A1
(43) Pub. Date: Apr. 13, 2023

(54) LIGHT SCANNING UNIT USING POLYGONAL MIRRORS WITH DIFFERENT NUMBERS OF DEFLECTION FACETS

(71) Applicant: HEWLETT-PACKARD DEVELOPMENT COMPANY, L.P., Spring, TX (US)

(72) Inventors: HeonHee LIM, Seongnam-si, Gyeonggi-do (KR); Jinkwon CHUN, Seongnam-si, Gyeonggi-do (KR)

(21) Appl. No.: 17/908,048

(22) PCT Filed: Mar. 1, 2021
(86) PCT No.: PCT/US2021/020219

§ 371 Date: Aug. 30, 2022

(30) Foreign Application Priority Data
Mar. 6, 2020 (KR) 10-2020-0028072

(51) Int. Cl. G03G 15/043; G02B 26/12

(52) U.S. Cl. CPC G03G 15/0435; G02B 26/12

(57) ABSTRACT

A light scanning unit includes a plurality of light source portions to emit modulated light beams intermittently according to image information of an image forming job while the image forming job is performed, and a plurality of polygonal mirrors, having different numbers of deflection facets, to rotate at a same rotational speed while is image forming job is performed so that the modulated light beams are incident on a subset including at least one of the deflection facets of the plurality of polygonal mirrors that rotate and the subset including the at least one of the deflection facets deflects the modulated light beams incident thereon to scan an object to be exposed.

### BACKGROUND

A light scanning unit employed in an electrophotographic developing type image forming apparatus deflectively scans a modulated light beam corresponding to image information in a main scanning direction of a photoconductor, which is an object to be exposed, and as the photoconductor rotates, an electrostatic latent image is formed on the photoconductor. The light scanning unit has an optical deflector, which is a polygonal mirror assembly, so as to deflectively scan the light beam emitted from a light source onto the photoconductor.

### BRIEF DESCRIPTION OF THE DRAWINGS

FIG. 1 is a view illustrating a schematic structure and operations of an example of an image forming apparatus.

FIG. 2 is a view illustrating an example of a light scanning unit.

FIG. 3 is a view illustrating another example of a light scanning unit.

FIG. 4 is a view illustrating an example of a main scanning plane of the light scanning unit.

FIG. 5 is a schematic perspective view of an example of the light scanning unit.

FIG. 6 is a view illustrating, an example where polygonal mirrors with different numbers of deflection facets rotating at a same rotational speed and a result of color registration being wrong due to using all of the deflection facets of each polygonal mirror.

FIG. 7 is a view illustrating an example where polygonal mirrors with different numbers of deflection facets rotating at a same rotational speed and color registration normally performed by using some of the deflection facets of each polygonal mirror.

FIG. 8 is a view illustrating another example where polygonal mirrors with different numbers of deflection facets rotating at a same rotational speed and color registration normally performed by using some of the deflection facets of each polygonal mirror.

FIG. 9 is a view illustrating a result of color registration being wrong due to an example of rotation of a photoconductor.

### DETAILED DESCRIPTION

Hereinafter, various examples will be described in detail with reference to the drawings. Furthermore, like reference numerals are used for elements having substantially the same function configurations in the present specification and the drawings and thus, a redundant description thereof is omitted.

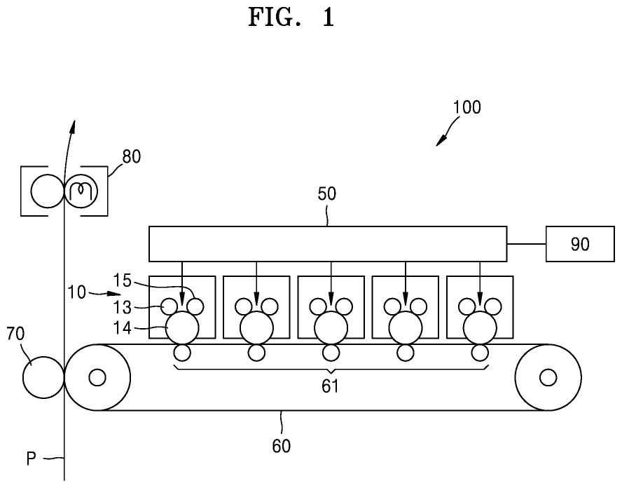

FIG. 1 is a view illustrating a schematic structure and operations of an image forming apparatus 100. The image forming apparatus 100 according to the present example may print a color image by using an electrophotographic developing method.

The image forming apparatus 100 collectively refers to a device capable of performing an image forming job, such as a printer, a copying machine, a multifunction machine, and a fax machine. The image forming job may include a variety of jobs relating to an image, for example, printing, copying, or faxing, and may include a series of processes carried out during the image forming job.

A developing unit 10 may include a photoconductor 14 having a surface on which an electrostatic latent image is formed, and a developing roller 13 that supplies a developing agent to the electrostatic latent image so as to develop the electrostatic latent image into a visible toner image. A photoconductive drum may be an organic photoconductor (OPC) as an example of the photoconductor 14. A charging roller 15 is an example of a charger that charges the photoconductor 14 so as to have a uniform surface electric potential. The developing agent accommodated in a developing agent cartridge (not shown) may be supplied to the developing unit 10. The developing agent accommodated in the developing agent cartridge (not shown) may be a toner.

A light scanning unit 50 scans modulated light corresponding to image information on the photoconductor 14 to form an electrostatic latent image on the photoconductor 14 and may include a laser scanning unit (LSU) as a representative example. Image forming apparatus 100 may also include processor 90 in an example.

A transfer unit may transfer the toner image formed on the photoconductor 14 to a print medium P and may be an intermediate transfer type transfer unit. In an example, the transfer unit may include an intermediate transfer body 60, an intermediate transfer roller 61, and a transfer roller 70, as shown in FIG. 1. An intermediate transfer belt shown in FIG. 1 is an example of the intermediate transfer body 60 to which the toner image developed on the photoconductor 14 of each of a plurality of developing units 10 is transferred and may temporarily accommodate the toner image. An intermediate transfer bias voltage for intermediately transferring the toner image developed on the photoconductor 14 to the intermediate transfer body 60 may be applied to a plurality of intermediate transfer rollers 61. The transfer roller 70 may be located to face the intermediate transfer body 60.

The print medium P may be transported along a feed path R and thus may be transported between the transfer roller 70 and the intermediate transfer body 60. The toner image intermediately-transferred to the intermediate transfer body 60 by a transfer bias voltage applied to the transfer roller 70 may be transferred to the print medium P transported between the transfer roller 70 and the intermediate transfer body 60. As the print medium P passes through a fusing unit 80, the toner image is fixed to the print medium P by heat and/or by pressure. The print medium P on which fusing of the toner image is completed, may be discharged by a discharge roller (not shown).

Through the above-described example configuration, the light scanning unit 50 may scan modulated light corresponding to image information of each color on the photoconductor 14 corresponding to each color, thereby forming an electrostatic latent image corresponding to each color. The electrostatic latent image of each photoconductor 14 of the plurality of developing units 10 may be developed into the visible toner image by using the developing agent supplied to each of the plurality of developing units 10 from a plurality of developing agent cartridges (not shown). The developed toner images may be intermediately transferred to the intermediate transfer body 60.

As shown in FIG. 1, the image forming apparatus 100 that outputs a color image by using a toner of five colors, may include five developing units 10 corresponding to each of five colors. For example, electrostatic latent images corresponding to image information of four basic colors, such as cyan (C), magenta (M), yellow (Y), and black (K), and an additional color A such as white or gold, may be formed on each of the five photoconductors 14. Each photoconductor 14 may form the toner images of C, M, Y, K, and A by using the supplied toner of each color. The toner images of C, M, Y, K, and A may be overlapped and transferred to the intermediate transfer belt 60, and then transferred to the print medium P again by the transfer roller 70. In FIG. 1, the image forming apparatus 100 including five developing units 10 so as to output a color image by using the toner of five colors has been illustrated as an example. However, examples of the disclosure are not limited thereto. The image forming apparatus 100 may also include six or more developing units 10 so as to user a toner of six or more colors.

A light scanning unit 50, on which five fight beams are scanned, outputs the color image based on five colors shown in FIG. 1. In order to scan five light beams on each photoconductor 14 that is an object to be exposed, the light scanning unit 50 may include a plurality of polygonal mirrors.

If the plurality of polygonal mirrors have different numbers of deflection facets (or reflection facets), a method of differently controlling the rotational speed of the polygonal mirrors may be considered for color registration. However, if different rotation control signals are used so as to differently control the rotational speed of the polygonal mirrors, clock signals may fluctuate due to component characteristics or noise. Hereinafter, the structure and operations of the light scanning unit 50 having the plurality of polygonal mirrors with different numbers of deflection facets will be firstly described. Then, a method of controlling the operations of the light scanning unit 50 by which the plurality of polygonal mirrors may rotate together rotated by using one rotation control signal and color registration between scanning lines may be performed, will be described.

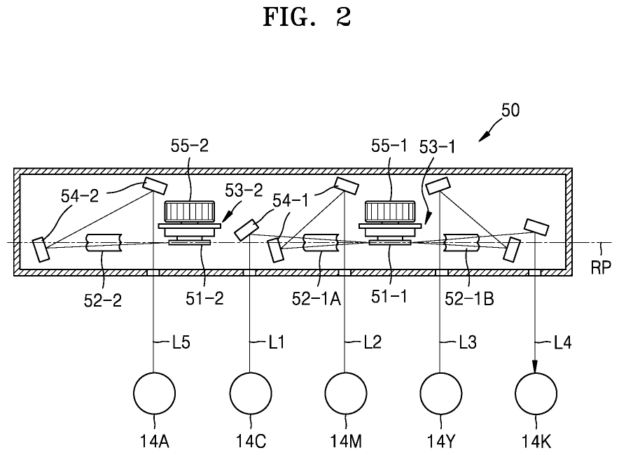

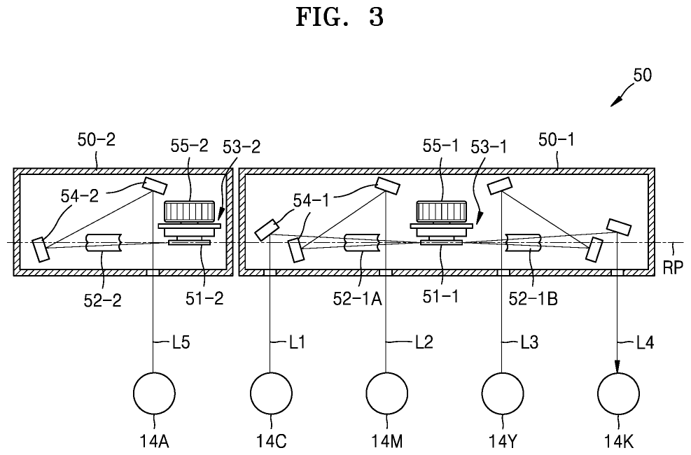

FIG. 2 is a view illustrating an example of the light scanning unit 50. FIG. 3 is a view illustrating another example of the light scanning unit 50. FIGS. 2 and 3 each illustrate an example of a sub-scanning plane of the light scanning unit 50.

Referring to FIGS. 2 and 3, the light scanning unit 50 may employ optical deflectors 53-1 and 53-2 having polygonal mirrors 51-1 and 51-2, respectively, with different numbers of deflection facets.

A first optical deflector 53-1 may include a first polygonal mirror 51-1 having a plurality of deflection facets, and a motor portion 55-1 that supports and rotates the first polygonal mirror 51-1. A second optical deflector 53-2 may include a second polygonal mirror 51-2 having a plurality of deflection facets, and a motor portion 55-2 that supports and rotates the second polygonal mirror 51-2. For convenience of explanation, the case where the first polygonal mirror 51-1 has six deflection facets and the second polygonal mirror 51-2 has four deflection facets, will be described. However, examples of the disclosure are not limited thereto.

The light scanning unit 50 may further include imaging lenses 52-1 and 52-2 for imaging by scanning each of light beams L1, L2, L3, L4, and L5 deflected by the optical deflectors 53-1 and 53-2 on each of photoconductors 14C, 14M, 14Y, 14K, and 14A that are objects to be exposed, and reflection members 54-1 and 54-2 that change optical paths of the light beams. The imaging lenses 52-1 and 52-2 and the reflection members 54-1 and 54-2 may be further arranged, and are not limited to the example shown in FIG. 2 or 3.

The light scanning unit 50 may deflectively scan first through fifth light beams L1, L2, L3, L4, and L5 emitted from a plurality of light sources (not shown) that emit modulated light corresponding to image information of each color, in a main scanning direction by using the optical deflectors 53-1 and 53-2. The first through fifth light beams L1, L2, L3, L4, and L5 may be incident on the deflection facets of the optical deflectors 53-1 and 53-2 so as to be inclined with respect to a reference plane RP in a sub-scanning direction. The reference plane RP may be a plane that is orthogonal to a rotation axis of the optical deflectors 53-1 and 53-2 and includes incidence points of the deflection facets on which the first through fifth light beams L1, L2, L3, L4 and L5 are incident. The light scanning unit 50 may allow the first through fifth light beams L1, L2, L3, L4, and L5 deflected by the optical deflectors 53-1 and 53-2 to pass through the imaging lenses 52-1 and 52-2 and then to be scanned on each of the photoconductors 14C, 14M, 14Y, 14K, and 14A along the optical path changed by the reflection members 54-1 and 54-2 so that an electrostatic latent image corresponding to color may be formed on each of the photoconductors 14C, 14M, 14Y, 14K, and 14A. The electrostatic latent image formed on each of the photoconductors 14C, 14M, 14Y, 14K, and 14A may be developed into a visible toner image by using the developing agent supplied from the plurality of developing agent cartridges (not shown).

In the light scanning unit 50 according to an example of FIG. 2, two optical deflectors 53-1 and 53-2 having polygonal mirrors with different numbers of deflection facets are installed within a housing of one light scanning unit 50. Unlike in FIG. 2, in a light scanning unit 50 according to another example of FIG. 3, a first light scanning unit 50-1 and a second light scanning unit 50-2 are separated from each other.

Referring to FIG. 3, the first light scanning unit 50-1 may be a tandem-type unit that may deflectively scan the first through fourth light beams L1, L2, L3, and L4 each emitted from a first light source portion (not shown) in the main scanning direction by using the first optical deflector 53-1 employing the first polygonal mirror 51-1 with six deflection facets. The first light scanning unit 50-1 may allow the first through fourth light beams L1, L2, L3, and L4 deflected by the first optical deflector 53-1 to pass through the imaging lens 52-1 and then to be scanned on each of the photoconductors 14C, 14M, 14Y, and 14K along the optical path changed by the reflection members 54-1 so that an electrostatic latent image corresponding to color may be formed on each of the photoconductors 14C, 14M, 14Y, and 14K. The second light scanning unit 50-2 may deflectively scan the fifth light beam L5 emitted from a second light source portion (not shown) in the main scanning direction by using the second optical deflector 53-2 employing the second polygonal mirror 51-2 with four deflection facets. The second light scanning unit 50-2 may allow the fifth light beam L5 deflected by the second optical deflector 53-2 to pass through the imaging lens 52-2 and then to be scanned on the photoconductor 14A along the optical path changed by the reflection members 54-2 so that an electrostatic latent image corresponding to color may be formed on the photoconductor 14A. For example, the first light scanning unit 50-1 may deflectively scan modulated light beams on the photoconductors 14C, 14M, 14Y, and 14K that are objects to be exposed, corresponding to each of cyan, magenta, yellow, and black colors, and the second light scanning unit 50-2 may deflectively scan modulated light beams on the photoconductor 14A that is an object to be exposed, corresponding to an additional color.

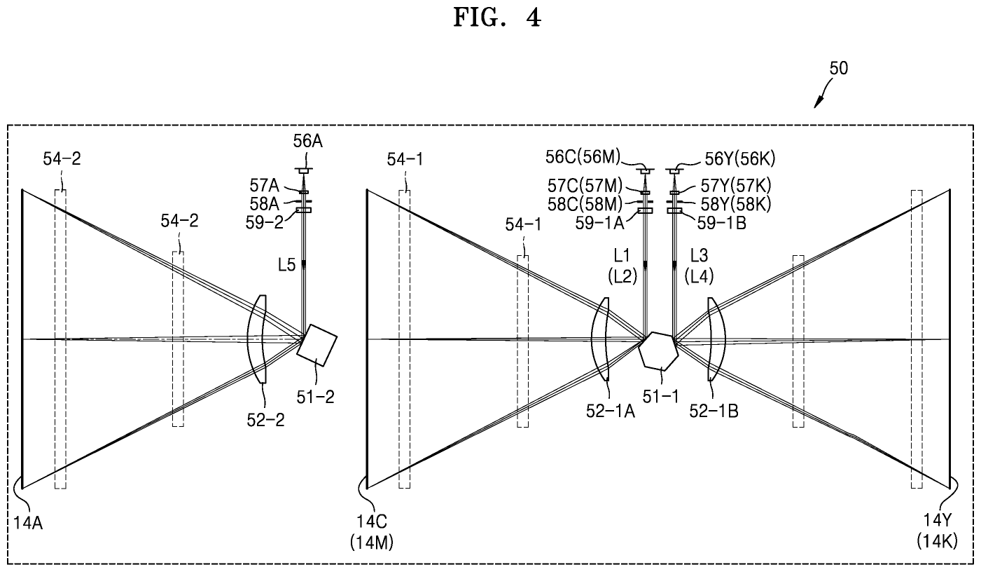

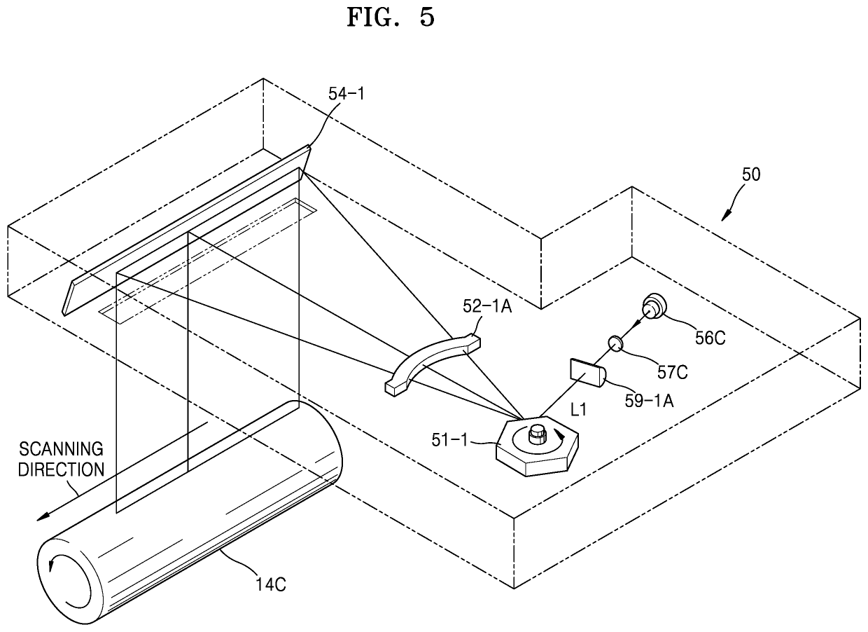

FIG. 4 is a view illustrating a main scanning plane of the light scanning unit 50. FIG. 5 is a schematic perspective view of an example of the light scanning unit 50. In FIG. 4, for convenience of explanation, the optical path changed by the reflection members 54-1 and 54-2 is not indicated, and overlapping components as the light beams L1, L2, L3, and L4 are obliquely incident on the polygonal mirror 51-1 in the sub-scanning direction, are shown as one.

Referring to FIGS. 4 and 5, the light scanning unit 50 according to an example that is a unit to scan the plurality of light beams L1, L2, L3, L4 and L5 in the main scanning direction, may include light sources 56C, 56M, 56Y, 56K, and 56A for emitting the first through fifth light beams L1, L2, L3, L4, and L5, collimating lenses 57C, 57M, 57Y, 57K, and 57A, apertures 58C, 58M, 58Y, 58K, and 58A, cylindrical lenses 59-1A, 59-1B, and 59-2, polygonal mirrors 51-1 and 51-2, imaging lenses 52-1A, 52-1B, and 52-2 for imaging the first through fifth light beams L1, L2, L3, L4, and L5 on the photoconductors 14C, 14M, 14Y, 14K, and 14A that are objects to be exposed, and reflection members 54-1 and 54-2.

Each of the light sources 56C, 56M, 56Y, 56K, and 56A may emit each of the first through fifth light beams L1, L2, L3, L4, and L5. For example, each of the light sources 56C, 56M, 56Y, 56K, and 56A may be a semiconductor laser diode that emits a laser beam.

Representatively, the optical path through which the first light beam L1 passes until the first light beam L1 emitted from the first light source 56C is scanned on a surface to be scanned of the first photoconductor 14C, will be described below.

A first collimating lens 57C may be located on the optical path between the first light source 56C and the first polygonal mirror 51-1. The first collimating lens 57C may be a condensing lens that makes the first light beam L1 emitted from the first light source 56C into parallel light. A first cylindrical lens 59-1A may be located on the optical path between the first collimating lens 57C and the first polygonal mirror 51-1. The first cylindrical lens 59-1A that is an optical element having certain power in the sub-scanning direction, may focus light passing through the first collimating lens 57C on the deflection facet of the first polygonal mirror 51-1 in the sub-scanning direction. A first aperture 58C for adjusting the diameter of beam may be further provided between the first collimating lens 57C and the first cylindrical lens 59-1A, The first collimating lens 57C, the first aperture 58C, and the first cylindrical lens 59-1A form an incident optical system of the light scanning unit 50. The first cylindrical lens 59-1A may be commonly used for the first light beam L1 and the second light beam L2.

The first polygonal mirror 51-1 may have different numbers of deflection facets from the number of deflection facets of the second polygonal mirror 51-2. As shown in FIG. 4, the first polygonal mirror 51-1 may have six deflection facets, and the second polygonal mirror 51-2 may have four deflection facets. However, examples of the disclosure are not limited thereto.

The first imaging lens 52-1A that is an example of an imaging optical system, may allow the first light beam L1 deflectively scanned by the first polygonal mirror 51-1 to be imaged on the surface to be scanned of the first photoconductor 14C. Referring to FIG. 4, an example in which the imaging optical system is configured of one first imaging lens 52-1A on the optical path through which the first light beam L1 and the second light beam L2 pass. However, the imaging optical system may be configured of two or more imaging lenses. The reflection member 54-1 is an example of an optical path-changing unit that properly changes the optical path of the first light beam L1 scanned.

In a similar way, each of the second through fifth light sources 56M, 56Y, 56K, and 56A may scan each of the second through fifth light beams L2, L3, L4, and L5 on the surface to be scanned of the photoconductors 14M, 14Y, 14K, and 14A.

The first light source 56C and the second light source 56M may be paired and may be arranged in parallel in a vertical direction. The third light source 56Y and the fourth light source 56K may be paired and may be arranged in parallel in the vertical direction. Each of the first light source 56C and the second light source 56M and the third light source 56Y and the fourth light source 56K may face each other based on the first polygonal mirror 51-1. The first through fourth light sources 56C, 56M, 56Y, and 56K may form a first light source portion. The fifth light source 56A may be arranged to make the fifth light beam L5 incident on the deflection facet of the second polygonal mirror 51-2 and may form a second light source portion. The number of light sources and an arrangement shape are not limited thereto and may be variously modified. The first through fifth light sources 56C, 56M, 56Y, 56K, and 56A may be arranged on one circuit board.

The first light beam L1 and the second light beam L2 may be incident on the same incidence point of the deflection facets of the first polygonal mirror 51-1, and the third light beam L3 and the fourth light beam L4 may be incident on the same incidence point of the deflection facets of the first polygonal mirror 51-1, and the fifth light beam L5 may be incident on an incidence point of the deflection facets of the second polygonal mirror 51-2. Incidence points on which the first through fifth light beams L1, L2, L3, L4, and L5 are incident, may be included in one plane. However, examples of the disclosure are not limited thereto.

A first imaging lens 52-1A from among the first imaging lenses 52-1A and 52-1B arranged at both sides of the first polygonal mirror 51-1 so as to face each other, may image each of the first beam L1 and the second beam L2 on an outer circumferential surface of each of the first photoconductor 14C and the second photoconductor 14M, and the first imaging lens 52-1B may image each of the third light beam L3 and the fourth light beam L4 on an outer circumferential surface of the third photoconductor 14Y and the fourth photoconductor 14K. The second imaging lens 52-2 may image the fifth light beam L5 on an outer circumferential surface of the fifth photoconductor 14A.

The first reflection member 54-1 and the second reflection member 54-2 may be members for changing the optical path of the first through fifth light beams L1, L2, L3, L4 and L5, and a reflection mirror or total reflection prism may be employed as the first reflection member 54-1 and the second reflection member 54-2. The first reflection member 54-1 and the second reflection member 54-2 may adjust an inclination angle or the shape of the deflection facets, thereby adjusting a change of the optical path of the first through fifth light beams L1, L2, L3, L4, and L5. The first reflection member 54-1 and the second reflection member 54-2 may change the optical path of each of the first through fifth light beams L1, L2, L3, L4, and L5 passing through one of the first imaging lenses 52-1A and 52-1B and the second imaging lens 52-2 so as to face each of the photoconductors 14C, 14M, 14Y, 14K, and 14A that are objects to be exposed.

In FIG. 5, for convenience of explanation, the first light beam L1 deflectively scanned on the first photoconductor 14C is indicated. Referring to FIG. 5, the first light beam L1 emitted from the first light source 56C may be incident on the deflection facets of the first polygonal mirror 51-1 and then may be deflectively scanned on the first photoconductor 14C that is an object to be exposed, in the main scanning direction. The first collimating lens 57C may be arranged on the optical path between the first light source 56C and the first polygonal mirror 51-1 so as to make the first light beam L1 into parallel light. The first cylindrical lens 59-1A that focuses the first fight beam L1 so as to image the first light beam L1 on the deflection facet of the first polygonal mirror 51-1, may be arranged between the first collimating lens 57C and the first polygonal mirror 51-1. The first light beam L1 deflected from the deflection facets of the first polygonal mirror 51-1 may pass through the first imaging lens 52-1A, may be reflected by the first reflection member 54-1 on the optical path and then may be imaged on the surface to be scanned of the first photoconductor 14C that is an object to be exposed.

Based on the above-described structure and operations, hereinafter, a method, by which, while the light scanning unit 50 having a plurality of light source portions and the plurality of polygonal mirrors 51-1 and 51-2 with different numbers of deflection facets performs an image forming job, the plurality of polygonal mirrors 51-1 and 51-2 rotate at a same rotational speed and light beams are deflectively scanned on an object to be exposed so that color registration may be performed, will be described in detail.

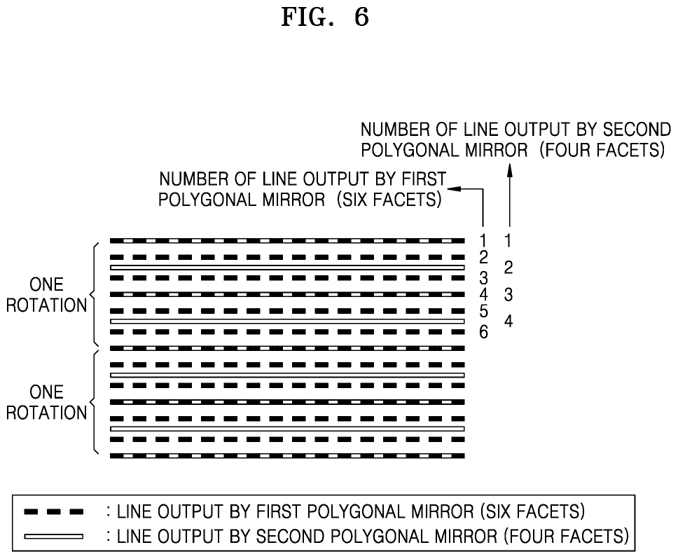

FIG. 6 is a view for describing the result of color registration by using all of the deflection facets of the polygonal mirrors 51-1 and 51-2 where the polygonal mirrors 51-1 and 51-2 with different numbers of deflection facets rotate at a same rotational speed.

Referring to FIG. 6, the first polygonal mirror 51-1 may have six deflection facets, and the second polygonal mirror 51-2 may have four deflection facets. The first polygonal mirror 51-1 and the second polygonal mirror 51-2 may rotate at a same rotational speed according to one rotation control signal. While rotating once, each of the first polygonal mirror 51-1 and the second polygonal mirror 51-2 may output six lines and four lines by using all of the deflection facets.

However, if the first polygonal mirror 51-1 and the second polygonal mirror 51-2 rotate at a same rotational speed according to one rotation control signal, as shown in FIG. 6, color registration may be wrong. If the polygonal mirrors 51-1 and 51-2 with different numbers of deflection facets rotate at a same rotational speed, the first polygonal mirror 51-1 may scan six lines, and the second polygonal mirror 51-2 may scan four lines during the same time at which each of the polygonal mirrors 51-1 and 51-2 rotates once.

Referring to FIG. 6, if the first polygonal mirror 51-1 outputs first through sixth lines while rotating once and the second polygonal mirror 51-2 outputs first through fourth lines while rotating once, color registration is wrong in the second line, the third line, the fifth line and the sixth line output by the first polygonal mirror 51-1 and the second line and the fourth line output by the second polygonal mirror 51-2.

On the other hand, color registration is normally performed in the first line and the fourth line output by the first polygonal mirror 51-1 and the first line and the third line output by the second polygonal mirror 51-2. In this way, based on that color registration is capable of being normally performed in some (for example, a subset including at least one) of the lines output by the first polygonal mirror 51-1 and the second polygonal mirror 51-2, hereinafter, a method, by which color registration is normally performed by using some (for example, a subset including at least one) of the deflection facets of the polygonal mirrors 51-1 and 51-2, will be described.

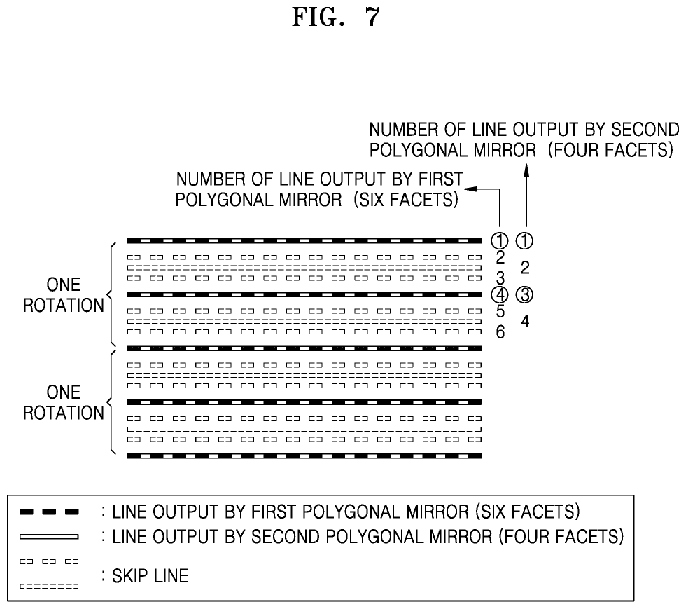

FIG. 7 is a view for describing an example in which color registration is normally performed by using some (for example, a subset including at least one) of the deflection facets of the polygonal mirrors 51-1 and 51-2 if the polygonal mirrors 51-1 and 51-2 with different numbers of deflection facets rotate at a same rotational speed.

Referring to FIG. 7, if the first polygonal mirror 51-1 and the second polygonal mirror 51-2 rotate at a same rotational speed according to one rotation control signal, the first polygonal mirror 51-1 may scan one line for every three of all of six facets, and the second polygonal mirror 51-2 may scan one line for every two of all of four facets. In order to scan one line for every three of deflection facets, the first polygonal mirror 51-1 may scan one line by using one deflection facet and then may skip a deflection facet with two facets and then may scan one line again by using the next deflection facet. In order to scan one line for every two of deflection facets, the second polygonal mirror 51-2 may scan one line by using one deflection facet and then may skip a deflection facet with one facet and then may scan one line again by using the next deflection facet.

As shown in FIG. 7, while the first polygonal mirror 51-1 rotates once, the first line and the fourth line may be output, and the second line, the third line, the fifth line, and the sixth line may not be output and may be skipped. While the second polygonal mirror 51-2 rotates once, the first line and the third line may be output, and the second line and the fourth line may not be output and may be skipped. As a result, it may be checked that color registration between the lines output by the first polygonal mirror 51-1 and the second polygonal mirror 51-2 is normally performed.

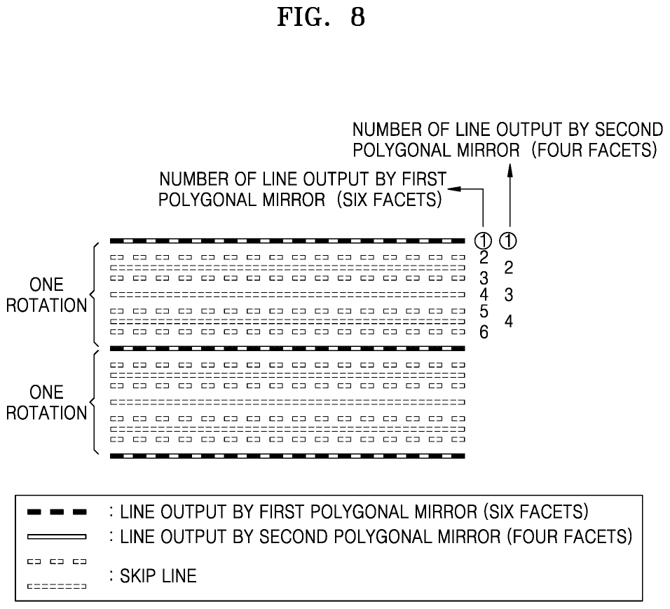

FIG. 8 is a view for describing another example in which color registration is normally performed by using some of the deflection facets of the polygonal mirrors 51-1 and 51-2 if the polygonal mirrors 51-1 and 51-2 with different numbers of deflection facets rotate at a same rotational speed.

Referring to FIG. 8, if the first polygonal mirror 51-1 and the second polygonal mirror 51-2 rotate at a same rotational speed according to one rotation control signal, the first polygonal mirror 51-1 may scan one line for every six of all of six deflection facets, and the second polygonal mirror 51-2 may scan one line for every four of all of four deflection facets. In order to scan one line for every six of deflection facets, the first polygonal mirror 51-1 may scan one line by using one deflection facet and then may skip a defection facet with five facets and then may scan one line again by using the next defection facet. In order to scan one line for every four of deflection facets, the second polygonal mirror 51-2 may scan one line by using one deflection facet and then may skip a deflection facet with three deflection facets and then may scan one line again by using the next deflection facet.

As shown in FIG. 8, while the first polygonal mirror 51-1 rotates once, the first line may be output, and the second through sixth lines may not be output and may be skipped. While the second polygonal mirror 51-2 rotates once, the first line may be output, and the second through fourth lines may not be output and may be skipped. As a result, it may be checked that color registration between the lines output by the first polygonal mirror 51-1 and the second polygonal mirror 51-2 is normally performed.

Summarizing the above description, while the light scanning unit 50 having a plurality of light source portions and the plurality of polygonal mirrors 51-1 and 51-2 with different numbers of deflection facets performs an image forming job, the plurality of polygonal mirrors 51-1 and 51-2 may rotate at a same rotational speed, and the plurality of light source portions may intermittently emit modulated light beams according to image information of the image forming job so as to be incident on some of deflection facets of the polygonal mirrors 51-1 and 51-2 that rotate, and may deflectively scan the light beams on an object to be exposed so that color registration may be normally performed. While an image forming job is performed, a processor 90 of the example of the image forming apparatus 100 of FIG. 1 may rotate the plurality of polygonal mirrors 51-1 and 51-2 according to the same rotation control signal and may intermittently drive the light source portions according to a driving control signal so that modulated light beams according to the image information of the information forming job may be incident on some of the deflection facets of the polygonal mirrors 51-1 and 51-2 that rotate.

While the image forming job is performed, the polygonal mirrors 51-1 and 51-2 that rotate, may have deflection facets with different periods, on which the modulated light beams are incident. In other words, while the image forming job is performed, the polygonal mirrors 51-1 and 51-2 that rotate may have different numbers of deflection facets skipped so that the modulated light beams may not be incident thereon.

To this end, while the image forming job is performed, the light source portions may emit modulated light beams such that periods of the deflection facets on which the modulated light beam is incident are different for each of the rotating polygon mirrors 51-1 and 51-2. In other words, while the image forming job is performed, the light source portions may emit the modulated light beams for every deflection facet skipped by a different number for each polygonal mirror, with respect to each of the polygonal mirrors 51-1 and 51-2 that rotate. In this way, the processor 90 of the image forming apparatus 100 may drive the light source portions according to the driving control signal so that the light source portions may intermittently emit the modulated light beams.

While the image forming job is performed, the light source portions may emit the modulated light beams with respect to each of the polygonal mirrors 51-1 and 51-2 that rotate and then may emit modulated light beams for every deflection facet corresponding to an integer multiple of a number obtained by dividing the number of all of deflection facets of each of the polygonal mirrors 51-1 and 51-2 that rotate by the greatest common divisor thereof, so that color registration may be normally performed.

As shown in the examples of FIGS. 7 and 8, if the first polygonal mirror 51-1 having deflection facets with all of six facets and the second polygonal mirror 51-2 having deflection facets with all of four facets are used in the light scanning unit 50, for color registration, the periods of the deflection facets that may be used in each of the first polygonal mirror 51-1 and the second polygonal mirror 51-2 may be summarized in Table as below. That is, by dividing six facets and four facets by 2 that is the greatest common divisor of 6 and 4, one line may be scanned for every three and two of facets, or one line may be scanned for every (six facets, four facets), (nine facets, six facets). (twelve facets, eight facets), and (fifteen facets, ten facets) that is an integer multiple of three facets and two facets, so that color registration may be normally performed.

TABLE 1

| Number of | | |
|---|---|---|
| deflection facets | Six facets | Four facets |
| Per line | 3 | 2 |
| Periods of | 6 | 4 |
| deflection facets | 9 | 6 |
| | 12 | 8 |
| | 15 | 10 |
| | . . . | . . . |

In another example, if the first polygonal mirror 51-1 having the deflection facets with all of eight facets and the second polygonal mirror 51-2 having the deflection facets with all of four facets are used in the light scanning unit 50, for color registration, the periods of the deflection facets that may be used in each of the first polygonal mirror 51-1 and the second polygonal mirror 51-2 may be summarized in Table as below. That is, by dividing eight facets and four facets by 4 that is the greatest common divisor of 8 and 4, one line may be scanned for every two and one of facets, or one line may be scanned for every (four facets, two facets), (six facets, three facets), (eight facets, four facets), and (ten facets, five facets) that is an integer multiple of two facets and one facet, so that color registration may be normally performed.

TABLE 2

| Number of | | |
|---|---|---|
| deflection facets | Eight facets | Four facets |
| Per line | 2 | 1 |
| Periods of | 4 | 2 |
| deflection facets | 6 | 3 |
| | 8 | 4 |
| | 10 | 5 |
| | . . . | . . . |

In another example, if the first polygonal mirror 51-1 having the deflection facets with all of eight facets and the second polygonal mirror 51-2 having the deflection facets with all of five facets are used in the light scanning unit 50, for color registration, the periods of the deflection facets that may be used in each of the first polygonal mirror 51-1 and the second polygonal mirror 51-2 may be summarized in Table as below. That is, by dividing eight facets and five facets by 1 that is the greatest common divisor of 8 and 5, one line may be scanned for every eight and five of facets, or one line may be scanned for every (sixteen facets, ten facets), (twenty-four facets, fifteen facets), (thirty-two facets, twenty facets), and (forty facets, twenty-five facets) that is an integer multiple of eight facets and five facets, so that color registration may be normally performed,

TABLE 3

| Number of | | |
|---|---|---|
| deflection facets | Eight facets | Five facets |
| Per line | 8 | 5 |
| Periods of | 16 | 10 |
| deflection facets | 24 | 15 |
| | 32 | 20 |
| | 40 | 25 |
| | . . . | . . . |

In another example, if the first polygonal mirror 51-1 having the deflection facets with all of eight facets and the second polygonal mirror 51-2 having the deflection facets with all of six facets are used in the light scanning unit 50, for color registration, the periods of the deflection facets that may be used in each of the first polygonal mirror 51-1 and the second polygonal mirror 51-2 may be summarized in Table as below. That is, by dividing eight facets and six facets by 2 that is the greatest common divisor of 8 and 6, one line may be scanned for every four and three of facets, or one line may be scanned for every (eight facets, six facets), (twelve facets, nine facets), (sixteen facets, twelve facets), and (twenty facets, fifteen facets) that is an integer multiple of four facets and three facets, so that color registration may be normally performed.

TABLE 4

| Number of | | |
|---|---|---|
| deflection facets | Eight facets | Six facets |
| Per line | 4 | 3 |
| Periods of | 8 | 6 |
| deflection facets | 12 | 9 |
| | 16 | 12 |
| | 20 | 15 |
| | . . . | . . . |

In another example, if the first polygonal mirror 51-1 having the deflection facets with all of six facets and the second polygonal mirror 51-2 having the deflection facets with all of five facets are used in the light scanning unit 50, for color registration, the periods of the deflection facets that may be used in each of the first polygonal mirror 51-1 and the second polygonal mirror 51-2 may be summarized in Table as below. That is, by dividing six facets and five facets by 1 that is the greatest common divisor of 6 and 5, one line may be scanned for every six and five of facets, or one line may be scanned for every (twelve facets, ten facets), (eighteen facets, fifteen facets), (twenty-four facets, twenty facets), and (thirty facets, twenty-five facets) that is an integer multiple of six facets and five facets, so that color registration may be normally performed.

TABLE 5

| Number of | | |
|---|---|---|
| deflection facets | Six facets | Five facets |
| Per line | 6 | 5 |
| Periods of | 12 | 10 |
| deflection facets | 18 | 15 |
| | 24 | 20 |
| | 30 | 25 |
| | . . . | . . . |

In another example, if the first polygonal mirror 51-1 having the deflection facets with all of five facets and the second polygonal mirror 51-2 having the deflection facets with all of four facets are used in the light scanning unit 50, for color registration, the periods of the deflection facets that may be used in each of the first polygonal mirror 51-1 and the second polygonal mirror 51-2 may be summarized in Table as below. That is, by dividing five facets and four facets by 1 that is the greatest common divisor of 5 and 4, one line may be scanned for every five and four of facets, or one line may be scanned for every (ten facets, eight facets), (fifteen facets, twelve facets), (twenty facets, sixteen facets), and (twenty-five facets, twenty facets) that is an integer multiple of five facets and four facets, so that color registration may be normally performed.

TABLE 6

| Number of | | |
|---|---|---|
| deflection facets | Five facets | Four facets |
| Per line | 5 | 4 |
| Periods of | 10 | 8 |
| deflection facets | 15 | 12 |
| | 20 | 16 |
| | 25 | 20 |
| | . . . | . . . |

Even if polygonal mirrors having three different types of deflection facets are used in the light scanning unit 50, color registration may be normally performed in a similar way.

For example, if the polygonal mirrors having four facets, five facets, and six facets are used in the light scanning unit 50, for color registration, the periods of the deflection facets that may be used in each of the polygonal mirrors may be summarized in Table as below. That is, by dividing each of four facets, five facets and six facets by 1 that is the greatest common divisor of 4, 5, and 6, one line may be scanned for every four, five, and six of facets, or one line may be scanned for every (eight facets, ten facets, twelve facets), (twelve facets, fifteen facets, eighteen facets), (sixteen facets, twenty facets, twenty-four facets), and (twenty facets, twenty-five facets, thirty facets) that is an integer multiple of four facets, five facets, and six facets, so that color registration may be normally performed.

TABLE 7

| Number of | | | |
|---|---|---|---|
| deflection facets | Four facets | Five facets | Six facets |
| Per line | 4 | 5 | 6 |
| Periods of | 8 | 10 | 12 |
| deflection facets | 12 | 15 | 18 |
| | 16 | 20 | 24 |
| | 20 | 25 | 30 |
| | . . . | . . . | . . . |

In another example, if polygonal mirrors having deflection facets with four facets, five facets and eight facets are used in the light scanning unit 50, for color registration, the periods of the deflection facets that may be used in each of the polygonal mirrors may be summarized in Table as below. That is, by dividing each of four facets, five facets and eight facets by 1 that is the greatest common divisor of 4, 5, and 8, one line may be scanned for every four, five, and eight of facets, or one line may be scanned for every (eight facets, ten facets, sixteen facets), (twelve facets, fifteen facets, twenty-four facets), (sixteen facets, twenty facets, thirty-two facets), and (twenty facets, twenty-five facets, forty facets) that is an integer multiple of four facets, five facets, and eight facets, so that color registration may be normally performed.

TABLE 8

| Number of | | | |
|---|---|---|---|
| deflection facets | Four facets | Five facets | Eight facets |
| Per line | 4 | 5 | 8 |
| Periods of | 8 | 10 | 16 |
| deflection facets | 12 | 15 | 24 |
| | 16 | 20 | 32 |
| | 20 | 25 | 40 |
| | . . . | . . . | . . . |

In another example, if polygonal mirrors having deflection facets with four facets, six facets and eight facets are used in the light scanning unit 50, for color registration, the periods of the deflection facets that may be used in each of the polygonal mirrors may be summarized in Table as below. That is, by dividing each of four facets, six facets and eight facets by 2 that is the greatest common divisor of 4, 6, and 8, one line may be scanned for every two, three, and four of facets, or one line may be scanned for every (four facets, six facets, eight facets), (six facets, nine facets, twelve facets), (eight facets, twelve facets, sixteen facets), and (ten facets, fifteen facets, twenty facets) that is an integer multiple of two facets, three facets, and four facets, so that color registration may be normally performed.

TABLE 9

| Number of | | | |
|---|---|---|---|
| deflection facets | Four facets | Six facets | Eight facets |
| Per line | 2 | 3 | 4 |
| Periods of | 4 | 6 | 8 |
| deflection facets | 6 | 9 | 12 |
| | 8 | 12 | 16 |
| | 10 | 15 | 20 |
| | . . . | . . . | . . . |

In another example, if polygonal mirrors having deflection facets with five facets, six facets and eight facets are used in the light scanning unit 50, for color registration, the periods of the deflection facets that may be used in each of the polygonal mirrors may be summarized in Table as below. That is, by dividing each of five facets, six facets and eight facets by 1 that is the greatest common divisor of 5, 6, and 8, one line may be scanned for every five, six, and eight of facets, or one line may be scanned for every (ten facets, twelve facets, sixteen facets), (fifteen facets, eighteen facets, twenty-four facets), (twenty facets, twenty-four facets, thirty-two facets), and (twenty-five facets, thirty facets, forty facets) that is an integer multiple of five facets, six facets, and eight facets, so that color registration may be normally performed.

TABLE 10

| Number of | | | |
|---|---|---|---|
| deflection facets | Five facets | Six facets | Eight facets |
| Per line | 5 | 6 | 8 |
| Periods of | 10 | 12 | 16 |
| deflection facets | 15 | 18 | 24 |
| | 20 | 24 | 32 |
| | 25 | 30 | 40 |
| | . . . | . . . | . . . |

Even if polygonal mirrors having four different types of deflection facets are used in the light scanning unit 50, color registration may be normally performed in a similar way.

For example, if the polygonal mirrors having four facets, five facets, six facets and eight facets are used in the light scanning unit 50, for color registration, the periods of the deflection facets that may be used in each of the polygonal mirrors may be summarized in Table as below. That is, by dividing each of four facets, five facets, six facets and eight facets by 1 that is the greatest common divisor of 4, 5, 6, and 8, one line may be scanned for every four, five, six and eight of facets, or one line may be scanned for every (eight facets, ten facets, twelve facets, sixteen facets), (twelve facets, fifteen facets, eighteen facets, twenty-four facets), (sixteen facets, twenty facets, twenty-four facets, thirty-two facets), and (twenty facets, twenty-five facets, thirty facets, forty facets) that is an integer multiple of four facets, five facets, six facets and eight facets, so that color registration may be normally performed.

TABLE 11

| Number of | | | | |
|---|---|---|---|---|
| deflection facets | Four facets | Five facets | Six facets | Eight facets |
| Periods of | 4 | 5 | 6 | 8 |
| deflection facets | 8 | 10 | 12 | 16 |
| per line | 12 | 15 | 18 | 24 |
| | 16 | 20 | 24 | 32 |
| | 20 | 25 | 30 | 40 |
| | . . . | . . . | . . . | . . . |

Furthermore, even if N different types of polygonal mirrors with different numbers of deflection facets are used in the light scanning unit 50, color registration may be normally performed in a similar way.

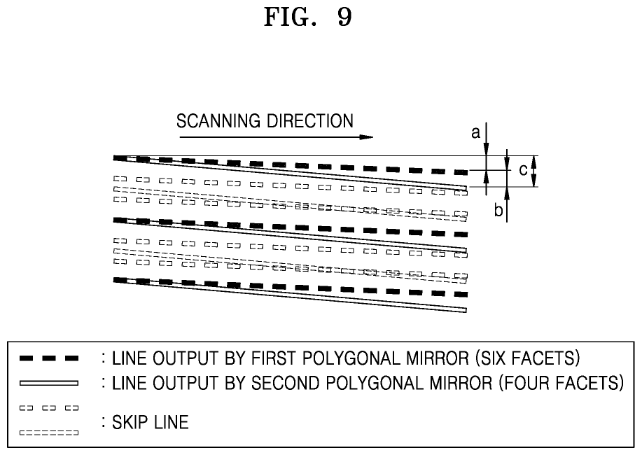

FIG. 9 is a view for describing the result in which color registration is wrong due to an example of rotation of the photoconductor 14.

As described above, if the polygonal mirrors 51-1 and 51-2 with different numbers of deflection facets rotate at a same rotational speed, although color registration is performed by using some of the deflection facets of the polygonal mirrors 51-1 and 51-2, wrong color registration may occur due to rotation of the photoconductor 14. If the first polygonal mirror 51-1 and the second polygonal mirror 51-2 have a same rotational speed, scanning speeds for one line output by the first polygonal mirror 51-1 and the second polygonal mirror 51-2 may be different from each other. Thus, as shown in FIG. 9, because a degree of skew of a line output by the first polygonal mirror 51-1 and a degree of skew of a line output by the second polygonal mirror 51-2 are different from each other, wrong color registration between the lines output by the first polygonal mirror 51-1 and the second polygonal mirror 51-2 may be checked.

In this case, skew may be compensated for in an opposite direction in correspondence with askew of a line due to rotation of the photoconductor 14 so that color registration may be normally performed. Compensation of skew in the opposite direction may be set inside the light scanning unit 50 or if the light scanning unit 50 is assembled with the image forming apparatus 100.

A method of controlling the operations of the light scanning unit 50 or the image forming apparatus 100 described above can be implemented in the form of a computer readable storage medium for storing commands that can be executed by a computer or processor. The method can be made as a computer executable program and can be implemented by a general-purpose digital computer that operates the program by using a computer readable storage medium. The computer readable storage medium may include read-only memory (ROM), random-access memory (RAM), flash memory, CD-ROMs, CD-Rs, CD+Rs, CD-RVVs, CD+RVVs, DVD-ROMs, DVD-Rs, DVD+Rs, DVD-RVVs, DVD+RWs, DVD-RAMs, BD-ROMs, BD-Rs, BD-R LTHs, BD-REs, a magnetic tape, a floppy disks, a magneto-optical data storage device, an optical data storage device, a hard disk, a solid state disk (SSD), and any device that can store commands or software, relating data, data files and data structures and can provide commands or software, relating data, data files and data structures to a processor or computer so that the processor or computer can execute the commands.

What is claimed is:

1. A light scanning unit comprising:
a plurality of light source portions to emit modulated light beams intermittently according to image information of an image forming job while the image forming job is performed; and
a plurality of polygonal mirrors, having different numbers of deflection facets, to rotate at a same rotational speed while the image forming job is performed so that the modulated light beams are incident on a subset including at least one of the deflection facets of the plurality of polygonal mirrors that rotate and the subset including the at least one of the deflection facets to deflect the modulated light beams incident thereon to scan an object to be exposed.

2. The light scanning unit of claim 1, wherein, while the image forming job is performed, the polygonal mirrors that rotate have deflection facets with different periods, on which the modulated light beams are incident.

3. The light scanning unit of claim 1, wherein, while the image forming job is performed, different numbers of deflection facets of the polygonal mirrors that rotate are skipped so that the modulated light beams are not incident thereon.

4. The light scanning unit of claim 1, wherein, while the image forming job is performed, the light source portions to emit the modulated light beams such that periods of the deflection facets on which the modulated light beam is incident are different for each of the rotating polygon mirrors.

5. The light scanning unit of claim 1, wherein, while the image forming job is performed, the light source portions to emit the modulated light beams for every deflection facet skipped by a different number for each polygonal mirror, with respect to each of the polygonal mirrors that rotate.

6. The light scanning unit of claim 1, wherein, while the image forming job is performed, the light source portions to emit the modulated light beams with respect to each of the polygonal mirrors that rotate, and then emit the modulated light beams for every deflection facet that is an integer multiple of a number obtained by dividing the number of all of the deflection facets of each of the polygonal mirrors that rotate, by the greatest common divisor thereof.

7. The light scanning unit of claim 1, wherein
the plurality of light source portions comprising a first light source portion and a second light source portion,
the plurality of polygonal mirrors comprising a first polygonal mirror and a second polygonal mirror, and
the light scanning unit comprising:
a first light scanning unit comprising the first light source portion and the first polygonal mirror; and
a second light scanning unit comprising the second light source portion and the second polygonal mirror.

8. The light scanning unit of claim 7, wherein the first light scanning unit to deflectively scan the modulated light beams on the object to be exposed corresponding to each of cyan, magenta, yellow, and black colors, and
the second light scanning unit to deflectively scan the modulated light beams on the object to be exposed corresponding to an additional color.

9. An image forming apparatus comprising:
a plurality of photoconductors;
a light scanning unit comprising a plurality of light source portions and a plurality of polygonal mirrors with different numbers of deflection facets, the light scanning unit to deflectively scan light beams on the plurality of photoconductors; and
a processor, while an image forming job is performed, to rotate the plurality of polygonal mirrors according to a same rotation control signal and to intermittently drive the plurality of light source portions according to a driving control signal so that the modulated light beams according to image information of the image forming job are incident on a subset including at least one of the deflection facets of the polygonal mirrors that rotate.

10. The image forming apparatus of claim 9, wherein, while the image forming job is performed, the polygonal mirrors that rotate have deflection facets with different periods, on which the modulated light beams are incident.

11. The image forming apparatus of claim 9, wherein, while the image forming job is performed, different numbers of deflection facets of the polygonal mirrors that rotate are skipped so that the modulated light beams are not incident thereon.

12. The image forming apparatus of claim 9, wherein the processor, while the image forming job is performed, drives the light source portions so as to emit the modulated light beams such that periods of the deflection facets on which the modulated light beam is incident are different for each of the rotating polygon mirrors.

13. The image forming apparatus of claim 9, wherein the processor, while the image forming job is performed, drives the light source portions so as to emit the modulated light beams for every deflection facet skipped by a different number for each polygonal mirror, with respect to each of the polygonal mirrors that rotate.

14. The image forming apparatus of claim 9, wherein the processor, while the image forming job is performed, drives the light source portions so as to emit the modulated light beams with respect to each of the polygonal mirrors that rotate, and then to emit the modulated light beams for every deflection facet that is an integer multiple of a number obtained by dividing the number of all of the deflection facets of each of the polygonal mirrors that rotate, by the greatest common divisor thereof.

15. The image forming apparatus of claim 9, wherein
the plurality of light source portions comprising a first light source portion and a second light source portion,
the plurality of polygonal mirrors comprising a first polygonal mirror and a second polygonal mirror, and
the light scanning unit comprising:
a first light scanning unit comprising the first light source portion and the first polygonal mirror; and
a second light scanning unit comprising the second light source portion and the second polygonal mirror.
